(19) United States
(12) Patent Application Publication
(10) Pub. No.: US 2006/0097088 A1
(43) Pub. Date: May 11, 2006

(54) Nozzle for sealant cartridges

(76) Inventors: Andrew Willers, Helensvale (AU); Friedhelm Jezuchowski, Nunawading (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/527,487

(22) PCT Filed: Sep. 10, 2003
(86) PCT No.: PCT/AU03/01183

§ 371 Date: Sep. 19, 2005

(30) Foreign Application Priority Data
Sep. 11, 2002 (AU) 2002951335

(51) Int. Cl. B05B 1/00; B05B 1/26

(52) U.S. Cl. 239/600; 239/597; 239/601

(57) ABSTRACT

This invention concerns a nozzle (1) for sealant cartridges that are typically used in caulking guns. The nozzle (1) includes an inlet end portion (2) that enables attachment of the nozzle (1) to a cartridge. The nozzle (1) has a tapered body (9) that terminates at an outlet (4). The tapered body (9) includes a cavity formed with a cross-sectional profile of triangle, arcuate or a crescent shape. Such profile produces a correspondingly shaped bead that permits less skilled working of the bead to achieve the desired chamfer or bevel on the sealant.

### TECHNICAL FIELD

This invention relates to nozzles for sealant cartridges.

### BACKGROUND TO THE INVENTION

Sealants and fillers are widely used to form a body of material that can fill gaps or cracks or form material between two abutting surfaces. An example of such use is in the glazing of a domestic glass window pane in a window frame. A perimeter bead of sealant is first applied to the frame and a further bead is applied after the glass plane has been fitted to the frame. The further bead is applied around the circumference of the pane where the glass pane abuts the frame. The bead of sealant is then worked and shaped with a putty knife or similar tool to form a chamfered or bevelled surface of sealant. The sealant is flowable for application or forming purposes but becomes relatively non flowable by chemical cross-linking reactions or loss of solvent. After curing or drying the sealant may, if desired, be painted. Sealants can also be used as fillers to be used in surface preparation for subsequent painting.

Sealants can have a wide range of compositions including the well known classes of silicones, polysulfides and polyurethanes as well as acrylics.

Conventionally the sealants are applied from a storage cartridge which fits into a caulking gun. The cartridges are cylindrical shaped and typically have capacity of approximately 400 ml.

The outlet of the cartridge is typically male threaded. In use, a conventional nozzle is screw attached to the cartridge outlet after the outlet has been opened, usually by cutting the sealed tip off the outlet. The conventional nozzle has a frustoconical shape tapering inwards towards the tip of the nozzle. The nozzle may be cut at a selected point to obtain the desired bead diameter size. The nozzle may be also cut obliquely to assist the application of the bead to the working area.

In practice the working of the bead formed from conventional nozzles requires a reasonable amount of skill and experience to obtain the desired chamfered surface.

It is an object of the invention to provide an improved cartridge nozzle. Advantageously, the improved nozzle allows a chamfered surface to be obtained with inexperienced or DIY operators or more efficiently with experienced tradesmen.

### SUMMARY OF THE INVENTION

This invention provides in one form a nozzle for a sealant cartridge, the nozzle having a threaded inlet end portion for attachment to an outlet of a sealant cartridge and a body portion that extends away from the inlet end portion, the body portion having a cavity which tapers inwardly from the inlet end portion towards a nozzle outlet, the cavity being characterised in that the cross-sectional profile of the nozzle outlet is triangular, semi-circular or crescent shaped so as to produce a correspondingly shaped bead.

Preferably the cavity has a shape corresponding to the shape of the nozzle outlet. In one embodiment, the cross-sectional profile has the same general shape at positions from the nozzle outlet to at least 50% of the length of the nozzle measured from the nozzle outlet to the shoulder portion.

In a preferred form of the invention, the shape of the nozzle outlet and at least a part of the cavity are crescent shaped. In another embodiment, the outlet shape is arcuate, with one side comprising a parabolic, elliptical or irregular arc and the other side being a substantially straight line.

The invention will be further described with reference to preferred embodiments illustrated in the accompanying drawings.

### BRIEF DESCRIPTION OF THE DRAWINGS

FIG. 1 is a perspective view of a cartridge nozzle in accordance with an embodiment of the invention;

FIG. 2 is a cross-sectional profile of the cavity at position A in FIG. 1;

FIG. 3 is a cross-sectional profile of the cavity at position B in FIG. 1;

FIGS. 4(a) and (b) are an alternative profile at positions A and B of a second embodiment of the invention; and

FIGS. 5(a) and 5(b) are an alternative profile at positions A and B of a third embodiment of the invention.

### DETAILED DESCRIPTION OF THE EMBODIMENT

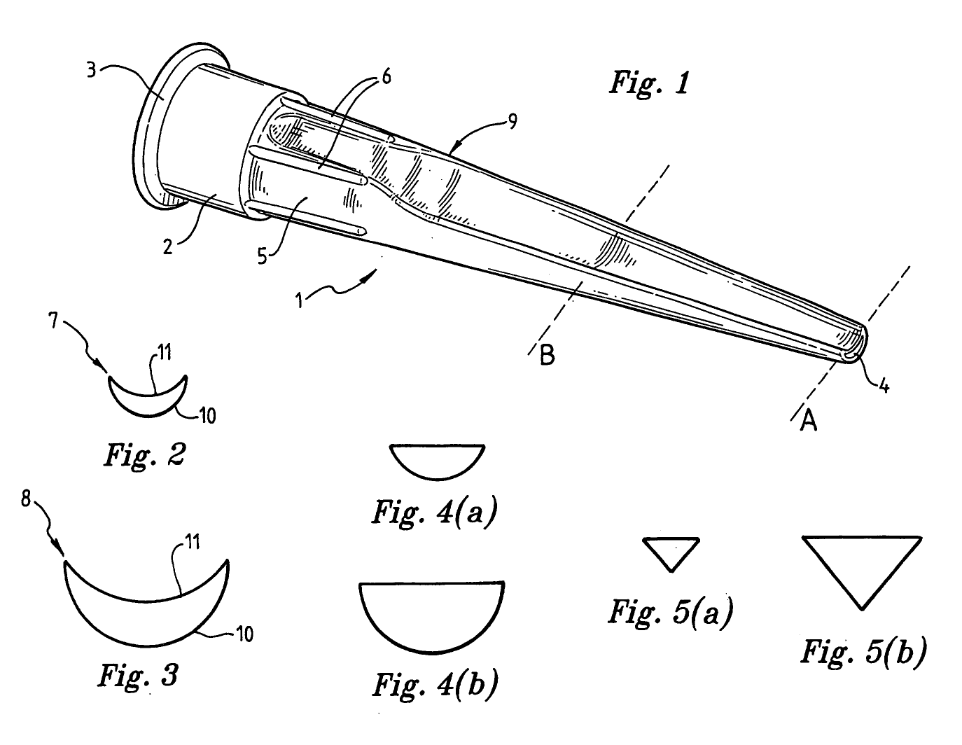

Referring to FIG. 1, the nozzle 1 includes an inlet end portion 2 which has an annular flange 3 and an internally (female) threaded portion. The nozzle 1 has a shoulder portion 5 with longitudinal rib members 6 that assist in providing grip for attaching and detaching the nozzle 1 from a cartridge. The shoulder portion 5 is attached to the end inlet portion 2 opposite the flange 3 and may taper inwardly away from the inlet end portion 2. The nozzle 1 has a body portion 9 extending longitudinally away from the shoulder portion 5 and inlet end portion 2, which tapers inwardly generally from the end of the shoulder portion 5 towards a nozzle outlet 4. The cross-section profile of the body portion 9 at the outlet 4 (position A) and a cental position B is shown in FIGS. 2 and 3 respectively where the profile at position A in FIG. 1 is shown as 7 and the profile at position B in FIG. 1 is shown as 8.

The profile of the cavity defined by the walls at position A (FIG. 2) is the same shape (but different size) to the profile at the mid point of the body portion 9 between the nozzle outlet 4 and the start of the shoulder portion 5. In each case, the profiles 7 and 8 comprise intersecting circular arcs 10 and 11.

In this embodiment, the relative shape of the arcs 10 and 11, is defined by a predetermined ratio of arc 10, 11 diameters. Preferably, the smaller diameter arc 10 forms a semi-circle and the larger diameter arc 11 has a diameter approximately 20% greater that the diameter of the smaller diameter arc 10, i.e a ratio of 1:1.2.

In use, the nozzle of the present invention is attached to a conventional sealant cartridge and the sealant is forced from the cartridge to the nozzle outlet 4 by a conventional caulking gun. The cross-sectional profile of the bead of sealant formed differs from the generally circular profile of sealant from a conventional nozzle. The shape of the sealant bead from the nozzle of the present invention corresponds to the shape of the cavity of the body portion 9 and, accordingly, allows less skilled working of the bead to achieve the desired chamfer or bevel. In some cases no further working is required thus saving time. By having the cavity cross-sectional profile constant in shape but not size it is possible to adjust the size of the bead by cutting or trimming the body portion of the nozzle. Normally a cut would not be made to leave less than 50% of the nozzle.

In this specification the term crescent profile shape means the curved shape formed by two intersecting curves as exemplified by the waxing crescent moon. The term is not confined to shapes formed by intersecting circular arcs, as shown in FIGS. 1-3, but also includes other curved shapes including ellipses, parabolas and irregular curves, including combinations of different shapes. The preferred crescent profile is defined by circular arcs. It will be appreciated that the term crescent also includes shapes that approximate a crescent. For example the ends of a crescent could have a radius and this would be often the case when the nozzle is injection moulded. It will also be appreciated that it is the cross-sectional profile of the outlet of the cavity that determines the shape of the bead. However, in most cases with uniform wall thickness the outer shape of the body portion 9 of the nozzle 1 will be similar in profile to that of the cavity. However, this is not necessary and the outer shape of the body portion 9 may have a different profile.

FIGS. 4(a) and (b) show an alternative cross-section profile of a nozzle at positions equivalent to positions A and B respectively in FIG. 1. In the case of FIG. 4, the profile is arcuate with one side being a straight line. This corresponds to a flat surface with the bead exits the nozzle outlet on application.

Similarly FIGS. 5(a) and (b) show an alternative triangular profile of a nozzle at positions equivalent to positions A and B respectively in FIG. 1. Such a profile also results in a bead with a flat surface.

The nozzles 1 of the present invention may be conveniently manufactured in polyethylene or other thermoplastic polymers by injection moulding. A cap for the nozzle may be integrally moulded with the nozzle. In use the cap is first detached from the nozzle. The wall thickness of the nozzle is similar to that of a conventional nozzle and can be, for example, 1 mm.

Those skilled in the art will appreciate that the invention described herein is susceptible to variations and modifications other than those specifically described. It will be understood that the present invention encompasses all such variations and modifications that fall within the spirit and scope.

1. A nozzle for a sealant cartridge, the nozzle having a threaded inlet end portion for attachment to an outlet of a sealant cartridge and a body portion that extends away from the inlet end portion, the body portion having a cavity which tapers inwardly from the inlet end portion towards a nozzle outlet, the cavity being characterised in that the cross-sectional profile of the nozzle outlet of the body portion is triangular, arcuate or crescent shaped so as to produce a correspondingly shaped bead.

2. A nozzle according to claim 1, wherein the nozzle outlet shape is a crescent and crescent shape comprises intersecting parabolic, elliptical or irregular arcs.

3. A nozzle according to claim 1, wherein the nozzle outlet shape is a crescent and the crescent shape comprises intersecting circular arcs.

4. A nozzle according to claim 3, wherein the arc shapes are defined according to a predetermined ratio of diameters.

5. A nozzle according to claim 4, wherein the ratio is 1:1.2.

6. A nozzle according to any one of claims 4 or 5, wherein the arc having a relatively smaller diameter forms a semi-circle.

7. A nozzle of claim 1, wherein the nozzle outlet shape is arcuate with one side comprising a parabolic, elliptical or irregular arc and the other side being a straight line.

8. A nozzle of claim 1, wherein the nozzle outlet shape is substantially triangular.

9. A nozzle according to any preceding claim, wherein the cavity has a shape corresponding to the shape of the nozzle outlet.

10. A nozzle according to any preceding claim, wherein the nozzle has a shoulder portion intermediate the inlet end portion and body portion, said shoulder portion including ribs to assist a user to grip the nozzle during attachment to and detachment from a cartridge.

11. A nozzle according to any preceding claim, wherein the cavity has a generally uniform crescent profile, of differing size according to the taper, from the nozzle outlet to at least a mid-point of the body portion away from the nozzle outlet.
